(19) United States
(12) Patent Application Publication
(10) Pub. No.: US 2025/0017825 A1
(43) Pub. Date: Jan. 16, 2025

(54) SYSTEMS AND APPROACHES FOR DRUG PROCESSING USING SINGLE-USE HARDWARE

(71) Applicant: AMGEN INC., Thousand Oaks, CA (US)

(72) Inventors: Todd Neslund, Thousand Oaks, CA (US); Stephen Karl Shutt, Oxnard, CA (US); Eunah Choi, Woodland Hills, CA (US); Alberto David Herrera, Ventura, CA (US); Jordan Ray Fine, Ventura, CA (US); Thomas Clark Pearson, Newbury Park, CA (US)

(21) Appl. No.: 18/577,029

(22) PCT Filed: Jun. 23, 2022
(86) PCT No.: PCT/US22/34718

§ 371 Date: Jan. 5, 2024

Related U.S. Application Data
(60) Provisional application No. 63/222,540, filed on Jul. 16, 2021.

(51) Int. Cl. A61J 7/02; G01N 15/14

(52) U.S. Cl. CPC A61J 7/02; G01N 15/14; G01N 2015/1486

(57) ABSTRACT

A system for dispensing, inspecting, and/or processing drug includes a tray adapted to be operably coupled with a workstation, a handle member operably coupled with the tray, and a funnel region operably coupled with the tray. The tray has a body defining a recessed region and a sidewall positioned adjacent to the recessed region. The handle member is positioned at or near a first corner of the tray. The funnel region is positioned at or near a second corner of the tray. The first corner is opposite the second corner.

### CROSS-REFERENCE TO RELATED APPLICATION

Priority is claimed to U.S. Provisional Patent Application No. 63/222,540, filed Jul. 16, 2021, the entire contents of which are hereby incorporated by reference herein.

### FIELD OF DISCLOSURE

The present disclosure generally relates to drug processing systems, and, more particularly, to systems for efficiently counting pills and/or tablets.

### BACKGROUND

Automated or semi-automated drug processing equipment may be used for a number of purposes such as, for example, counting pills and/or tablets in a low throughput setting such as pharmacies or other drug dispensing facilities. Such equipment may be used to fill bottles for patient use. Existing systems have several shortcomings with accuracy, efficiency, and/or ergonomics for them to be incorporated into manufacturing and/or processing environments having moderate-to-high throughput levels (e.g., thousands of bottles per day). In environments where exact pill counts are required, existing systems and processing may be too time consuming to be reliably used in large-scale processing environments.

More specifically, existing systems may require pills to be poured onto a tray until they receive a visual indication (e.g., a light illuminating) of a match between the required number of pills and the number of pills present on the tray. An imaging system may be used to perform or assist with the counting process. If the user poured too many pills onto the tray, they must be manually removed with forceps. Such a process is time consuming and is not suitable for manufacturing levels of throughput. Upon obtaining the correct quantity of pills on the tray, the tray may then be tilted forward and poured into a built-in funnel and into a bottle. Existing funnel systems may be undesirable in that they require validated cleaning methods to ensure that trace amounts from one drug product are not transferred to a subsequent drug product run. Some systems have addressed this problem by eliminating the use of the funnel and instead rely on a funnel-shaped corner to dispense the pills into the bottle. However, these systems still require manually removing excess pills with forceps, and may be difficult to properly orient and/or align the tray with the machine. Further, such systems may be expensive to manufacture and lack ergonomic features, instead requiring a user to grasp a small corner region of the tray with their fingertips, thereby potentially causing stress

As described in more detail below, the present disclosure sets forth systems and methods for drug processing using single use hardware embodying advantageous alternatives to existing systems and methods, and that may address one or more of the challenges or needs mentioned herein, as well as provide other benefits and advantages.

### SUMMARY

In accordance with a first aspect, a system for dispensing, inspecting, and/or processing a drug includes a tray adapted to be operably coupled with a workstation, a handle member operably coupled with the tray, and a funnel region operably coupled with the tray. The tray has a body defining a recessed region and a sidewall positioned adjacent to the recessed region. The handle member is positioned at or near a first corner of the tray. The funnel region is positioned at or near a second corner of the tray. The first corner is opposite the second corner.

In some examples, the system further includes a hopper positioned adjacent to a length of the body of the tray. In some of these approaches, the hopper may be in the form of a single use hopper that is removably positioned adjacent to the length of the body of the tray. Further, in some forms, the body of the tray may include a ridge extending from a portion of the recessed region.

In some examples, the handle member may include an arm member. The arm member may extend outwardly from the first corner of the tray and further may include a gripping member operably coupled with the arm member. The arm member may be pivotably coupled with the first corner of the tray.

In some approaches, the funnel region may include a ramp extending from the recessed region to an upper edge of the sidewall. Further, in these and other examples, the system may include an edge guide positioned adjacent to the second corner of the tray. The edge guide may include a raised wall extending from the sidewall of the body of the tray.

In some examples, the tray may include a flange extending around at least a portion of the sidewall. The flange may rest upon a portion of the drug processing system. Further, in some examples, the tray may be constructed from a vacuum molded material.

In accordance with a second aspect, a drug processing system includes a workstation including a platform and an imaging system, a dispensing system including a tray adapted to be operably coupled with the workstation, a handle member operably coupled with the tray, a funnel region operably coupled with the tray, and a counting system operably coupled with the workstation. The tray includes a body defining a recessed region and a sidewall positioned adjacent to the recessed region. The handle member is positioned at or near a first corner of the tray. The funnel region is positioned at or near a second corner of the tray. The first corner is opposite the second corner. The counting system is adapted to count a quantity of items sensed by the imaging system that are disposed on the recessed region of the tray.

In accordance with a third aspect, a drug processing system includes a workstation including a base and an elevated platform operably coupled therewith, and an inspection system including a tray adapted to be at least partially operably coupled with at least a portion of the elevated platform. The tray is constructed form an optically transparent material and includes a body defining a recessed region and a sidewall positioned adjacent to the recessed region. The inspection system further includes a funnel region operably coupled with the tray and positioned at or near a corner of the tray. The counting system is adapted to count a quantity of items sensed by the imaging system that are disposed on the recessed region of the tray

### BRIEF DESCRIPTION OF THE DRAWINGS

The above needs are at least partially met through provision of the systems and approaches for drug processing using single use hardware described in the following detailed description, particularly when studied in conjunction with the drawings, wherein:

FIG. 1 illustrates a perspective view of an example drug processing workstation in accordance with various embodiments;

FIG. 2 illustrates a perspective view of an example dispensing system for use with the example drug processing workstation in accordance with various embodiments; and

FIG. 3 illustrates a perspective view of an example inspection system for use with the example drug processing workstation in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a drug processing system having single-use hardware is provided. The system includes a pill (or tablet or capsule) counting mechanism capable of determining a quantity of pills or tablets disposed on a removable tray. The tray includes a sidewall that assists with quickly removing pills therefrom in the event an excess quantity of pills are initially disposed on the tray. The system includes a single-use hopper that may be disposed of upon a user The tray is ergonomic and requires minimal hand movement to dispense the pills or tablets into a pill bottle or similar packaging. Advantageously, the ergonomic features described herein may allow a user to repetitively perform counting and pouring functions over extended periods of time (e.g., an entire shift) without experiencing pain and/or fatigue.

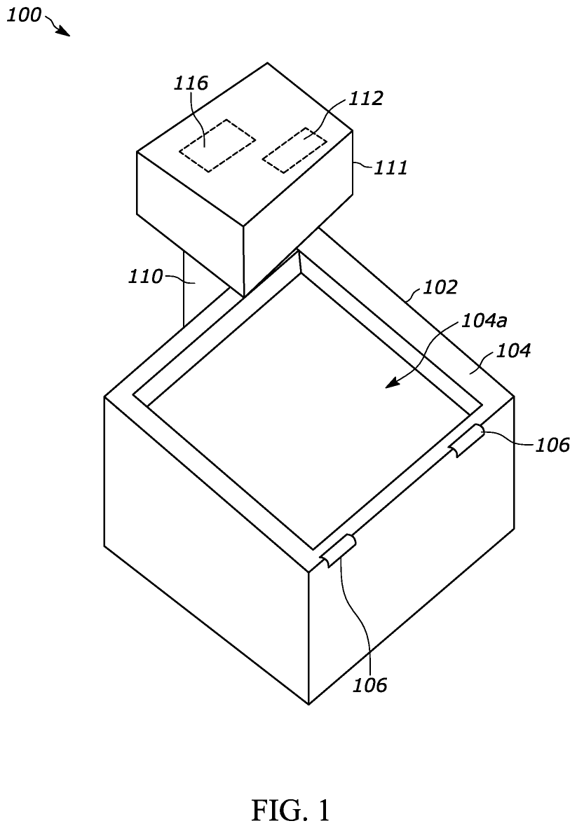

Turning to the Figures, a drug processing system 100 is provided. The system 100 includes a workstation 102 and a dispensing system 120. The workstation 102 includes a platform 104 and a computing system 108. Generally, the workstation 102 is in the form of an enclosure and/or box, and the platform 104 defines an upper area that includes a recess or placement region 104a thereon. As illustrated in FIG. 1, the workstation 102 further includes at least one hopper mounting member 106. The hopper mounting member or members 106 may be in the form of a ledge, a hook, protrusion, and the like, and may be disposed on a front surface of the workstation 102.

The computing system 108 includes an imaging system 112 and a counting system 116. In the illustrated example, the computing system 108 is generally disposed on an arm 110 operably coupled with and/or adjacent to the workstation 102, but other arrangements are possible. Further, in the illustrated example, the computing system 108 is at least partially disposed within an enclosure 111 disposed at an upper end of the arm 110. In other examples, portions of the computing system 108 may be disposed in separate enclosures remotely located. For example, the counting system 116 may be located at other locations of the workstation 102 and/or the system 100. The imaging system 112 may include any number of imaging sensors, lenses, illumination mechanisms, and the like to assist with capturing at least one image of an object or objects within a field of view (FOV). In the illustrated example, the imaging system 112 is positioned above and aimed at the platform 104.

The imaging system 112 is communicatively coupled with the counting system 116 and may receive the image or images of the objects disposed within the FOV. In some examples, the counting system 116 may include electrical and/or electromechanical components capable of identifying and counting the objects within the FOV. As previously noted, the counting system 116 may be communicatively coupled with the imaging system imaging system 112 within the enclosure 111. In some examples, the enclosure 111 may include an interface in the form of a display (not illustrated) to provide a visual representation of the number of objects counted by the counting system 116. In some examples, the display 116 may provide a numerical indicator of the number of objects. In these and other examples, the display may change colors depending on whether the number of objects counted by the counting system 116 matches the desired quantity. It is appreciated that the computing system 108 may include any number of additional components such as processors, memory modules, programs, executable instructions, and the like to assist in operation. Further, the computing system 108 may include any number of mechanical and electromechanical components, sub-components, systems, power sources, measuring devices, processors, controllers, and the like to operate in an autonomous or semi-autonomous manner.

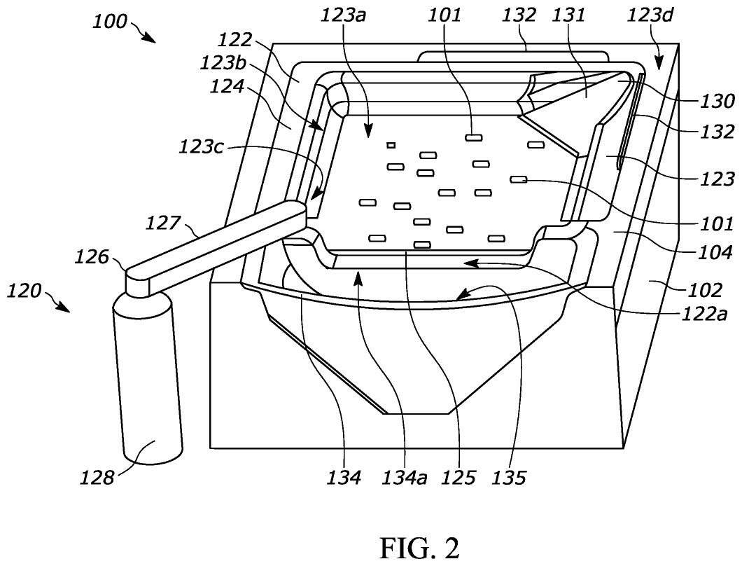

The dispensing system 120 includes a tray 122 having a body 123 defining recessed region 123a, a sidewall 123b positioned adjacent to the recessed region 123a, a first corner 123c, and a second corner 123d that is opposite the first corner 123c. The dispensing system 120 further includes a handle member 126, a funnel region 130, and a hopper 134. In some examples, the body 123, the handle member 126, and/or the funnel region 130 may be integrally formed, but in other examples, the handle member 126 and/or the funnel region 130 may be distinct components operably coupled with the body 130. As illustrated in FIG. 2, which does not include the arm 110 for the purposes of clarity, the tray 122 may also include a flange 124 that extends in a direction that is generally parallel to the platform 104a such that the flange 124 may rest on a portion of the drug processing system 100 (e.g., the platform 104). Generally, all or a portion of the recessed region 123a of the tray 122 is disposable within or on the recess or placement region 104a of the platform 104. In some examples, the tray 122 may be constructed from a vacuum molded material. Such a manufacturing process is advantageously less costly than conventional injection molding techniques. Other examples are possible. Further, in some examples, the body 123 is highly optically transparent to allow the imaging system 112 to accurately identify objects and/or shadows thereof.

A front side 122a of the tray 122 has a relatively lower sidewall 123b than the remaining sides of the tray 122. As will be discussed, the front side 122a of the tray 122 is positioned adjacent to a corresponding front portion of the platform 104 of the workstation 102. The recessed region 123a is a surface that receives the pills or tablets 101. In some examples, the recessed region 123a is generally planar to allow pills 101 to be evenly distributed thereacross, though other examples are possible. Notably, the entire recessed region 123a is adapted to be within the FOV of the imaging system 112 when the tray 122 is disposed on and/or within the platform 104.

The tray 122 further includes a ridge 125 that operates as a retention member. The ridge 125 is in the form of a raised section relative to the recessed region 123a that prevents pills 101 from inadvertently falling off the tray 122 (and into the hopper 130). In some examples, the ridge 125 is integrally formed with the recessed region 123a, and in other examples, the ridge 125 may be operably coupled with the recessed region 123a via any number of suitable approaches such as, for example, via adhesives, ultrasonic welding, a friction-fit engagement, and the like. Other examples are possible.

The handle member 126 is positioned at or near the first corner 123c of the body 123 of the tray 122. The handle member includes an arm member 127 extending outwardly from the first corner 123c a length that is beyond that of the workstation 102, and additionally includes a gripping member 128 operably coupled with the arm member 127. In some examples, the arm member 127 may be rotatably coupled with the tray 122 such that the arm member 127 may pivot or swivel relative to the tray 122. Similarly, in some examples, the gripping member 128 may also be rotatably coupled with the arm member 127 such that it may rotate. The gripping member 128 may be constructed from any number of suitable materials such as, for example, a soft, cushioned material, a material that increases grippability, and the like.

The funnel region 130 is positioned at or near the second corner 123d of the body 123 of the tray 122. In some examples, the funnel region 130 may be integrally formed with the tray 122, and in other examples, the funnel region 130 may be operably coupled with the tray 122 via any number of suitable approaches such as, for example, via adhesives, ultrasonic welding, a friction-fit engagement, and the like. The funnel region 130 includes a ramp 131 that extends from the recessed region 123a to an upper edge of the sidewall 123b. As illustrated in FIG. 2, the funnel region 130 may resemble a spout or a lip that may be used to direct the pills 101 into a desired container. In some examples, the funnel region 130 may also include any number of edge guides 132 positioned adjacent to the second corner 123d. The edge guide 132 is in the form of a raised wall that extends generally upwardly from the sidewall 123b. In some examples (and as illustrated) the edge guide 132 may be a generally planar member, and in other examples (not illustrated), the edge guide may be a curved member.

The hopper 134 is positioned along the front side 122a of the tray 122. Like the tray 122, in some examples, the hopper 134 may be constructed from a vacuum molded material. The hopper 134 is removably coupled with the workstation by coupling with the hopper mounting member 106. More specifically, in some examples, the hopper 134 may include a hook or tab (not illustrated) that engages the hopper mounting member 106 to secure the hopper 134 with the workstation 102. The hopper 134 includes a lowered region 134a and a bucket 135 positioned below the lowered region 134a to collect overfill pills 101. Notably, the hopper 134 is a single use hopper that may be discarded after each use and/or after all of a particular type of pill 101 are counted by the system 100. As such, the system 100 does not require a validated cleaning method of the hopper 134 to ensure no drug product residue is transferred from one type of pill 101 to a subsequent type of pill 101.

In use, a user may grasp the gripping member 128 to place the tray 122 on the workstation 102 such that the recessed region 123a of the tray 120 is operably coupled with, and in some versions, disposed within and/or on the placement region 104a of the platform 104. In this configuration, the entire recessed region 123a is disposed within the FOV of the imaging system 112. In some examples, the platform 104 may include an illumination system (e.g., a backlight, not illustrated) to assist the imaging system 112 and/or the counting system 116. In some examples, a user may input a desired number of pills 101 into the computing system 108, and begin pouring pills 101 onto the recessed region 123a. The sidewall 123b and the ridge 125 retain the pills 101 within the recessed region 123a. As the user pours pills 101 onto the recessed region 123a, the imaging system 112 sends an image or images of the FOV (and thus the pills 101 disposed on the recessed region 123a) to the counting system 116, which counts the number of pills 101 and determines if the counted number is equal to, greater than, or less than the desired number of pills 101. Notably, because the tray 123 is constructed from a highly optically transparent or clear material, the imaging system 112 may accurately capture images of the pills 101, and the counting system 116 may similarly accurately distinguish between pills 101 and shadows, if present. If the number of pills 101 counted by the counting system 116 is less than the desired number of pills 101, the computing system 108 may instruct the user to add more pills to the recessed region 123a. If the number of pills 101 counted by the counting system 116 is greater than the desired number of pills 101, a user may scrape excess pills 101 into the bucket 135a of the hopper 134 by urging them over the ridge 125.

Upon the number of pills 101 counted by the counting system 116 equaling the desired number of pills 101, the computing system 108 may provide an indication that the number of pills 101 has been obtained. A user may then grasp the gripping member 128, lift the tray 122 from the platform 104, and pour the pills 101 into a desired storage receptacle (e.g., a pill bottle; not illustrated) by angling the tray 122 downwards to cause the pills 101 to pour from the ramp 131 of the funnel region 130. Notably, the edge guide 132 will prevent pills 101 from inadvertently falling from the tray 122 and assists in directing pills 101 into the desired storage receptacle. A user may then place the tray 122 back onto the platform 104 to resume counting operations. In some examples, the pills 101 disposed within the bucket 135 may be returned to a container for subsequent counting processes, and in other examples, the pills 101 disposed within the bucket 135 may be discarded. Further, the hopper 134 itself may be discarded upon completing a desired counting operation and/or upon completing a batch of counting operations of a single type of pill 101.

So configured, by positioning the handle member 126 at the first corner 123c and the funnel region 130 at the second corner 123d, a user needn't unnecessarily twist their wrist to pour the pills 101 from the tray 122, thereby improving ergonomics and reducing user fatigue. Further, the tray 122 overcomes issues with undercounting pills 101 when they are positioned in the corners or sides of the tray 120 by moving the corners and sidewalls towards the center to ensure the entire recessed region 123a is within the FOV. The system 100 enables quick, accurate, and ergonomic counting of pills 101 for filling in clinical manufacturing facilities.

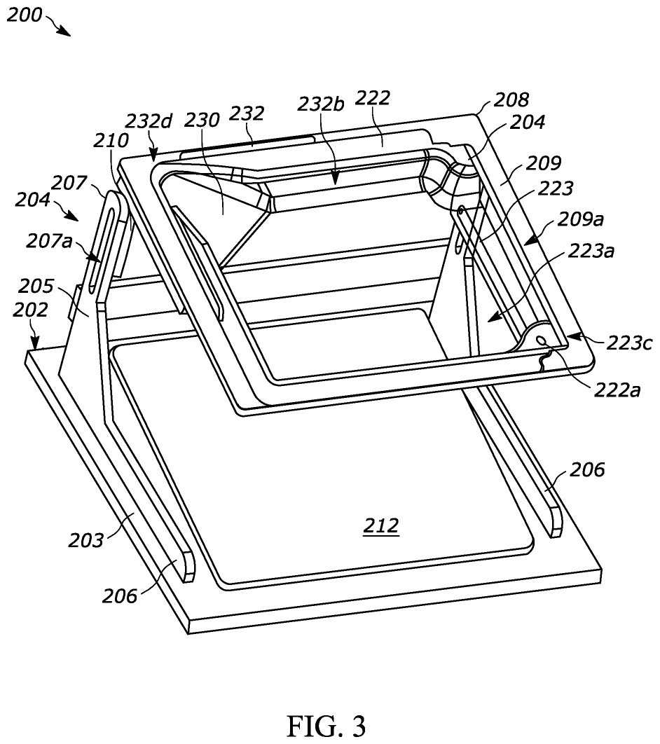

Turning now to FIG. 3, an alternative example drug processing system 200 is provided. In this example, the workstation 202 is in the form of an inspection station whereby a user (and/or a computing system; not illustrated) may inspect the top and the bottom of the pill 101 for blemishes and/or defects. In this example, an inspection system 220 includes a tray 222 having similar features as the tray 122 described with respect to FIGS. 1 and 2. Accordingly, these similar elements are denoted by identical two-digit suffixes in FIG. 3, and will not be described in substantial detail herein. It will be appreciated that any features of the system 200 illustrated in FIG. 3 may be incorporated into the system 100 illustrated in FIGS. 1 and 2, and vice-versa.

The workstation 202 includes a base 203 and an elevated platform 204 operably coupled with the base 203. More specifically, the elevated platform 204 includes at least one arm 205 having a mounting portion 206 and an elevated portion 207. In the illustrated example, the arm 205 is in the form of an L-shaped bracket, but other examples are possible. The mounting portion 206 is operably coupled with the base 203 via any number of suitable approaches such as, for examples, fasteners, adhesives, and the like. In other examples, the elevated platform 204 (i.e., the mounting portion 206) may simply rest on the base 203 without the use of fasteners or other securement mechanisms.

The elevated portion 207 of the arm 205 includes a slot 207a dimensioned to slidably couple with a portion of a platform frame 208. More specifically, the platform frame 208 includes a body 209 defining an opening 209a and any number of arms 210. The arm or arms 210 may include a protrusion (not illustrated) that slidably engages the slot 207a of the elevated portion 207 to allow the platform frame 208 to be raised or lowered relative to the base 203. In some examples, a fastener such as a bolt and nut (not illustrated) may be used to releasably couple the platform frame 208 with the arm 205.

The tray 222 is dimensioned to be operably coupled with and, in some versions, disposed within the opening 209a of the body 209. In the illustrated example, the tray 222 includes a flange 224 that rests on the body 209. In other examples, the tray 222 may be releasably secured with the body 209. Further, a reflective member 212 (e.g., a mirror) may be disposed on and/or coupled with the base 203. Accordingly, in examples where the tray 222 is constructed from an optically transparent material, contents such as pills disposed on the tray 222 may be inspected from both upper and lower sides without needing to be manually turned over. So arranged, particles or other defects may be viewed by a user and/or imaging system. In these and other examples, an illumination system (not illustrated) may be provided to assist with observing the pills. Advantageously, by using an optically transparent material for the tray 222, the presence of shadows on the pills may be reduced.

In some examples, the tray 222 may include an opening 222a or other mounting member to operably couple a handle (not illustrated) therewith. In such examples, a user may quickly and efficiently transfer the tray 222 between the counting workstation 102 and the inspection workstation 202.

The above description describes various devices, assemblies, components, subsystems and methods for use related to a drug delivery device. The devices, assemblies, components, subsystems, methods or drug delivery devices can further comprise or be used with a drug including but not limited to those drugs identified below as well as their generic and biosimilar counterparts. The term drug, as used herein, can be used interchangeably with other similar terms and can be used to refer to any type of medicament or therapeutic material including traditional and non-traditional pharmaceuticals, nutraceuticals, supplements, biologics, biologically active agents and compositions, large molecules, biosimilars, bioequivalents, therapeutic antibodies, polypeptides, proteins, small molecules and generics. Non-therapeutic injectable materials are also encompassed. The drug may be in liquid form, a lyophilized form, or in a reconstituted from lyophilized form. The following example list of drugs should not be considered as all-inclusive or limiting.

The drug will be contained in a reservoir. In some instances, the reservoir is a primary container that is either filled or pre-filled for treatment with the drug. The primary container can be a vial, a cartridge or a pre-filled syringe.

In some embodiments, the reservoir of the drug delivery device may be filled with or the device can be used with colony stimulating factors, such as granulocyte colony-stimulating factor (G-CSF). Such G-CSF agents include but are not limited to Neulasta® (pegfilgrastim, pegylated filgastrim, pegylated G-CSF, pegylated hu-Met-G-CSF) and Neupogen® (filgrastim, G-CSF, hu-MetG-CSF), UDENYCA® (pegfilgrastim-cbqv), Ziextenzo® (LA-EP2006; pegfilgrastim-bmez), or FULPHILA (pegfilgrastim-bmez).

In other embodiments, the drug delivery device may contain or be used with an erythropoiesis stimulating agent (ESA), which may be in liquid or lyophilized form. An ESA is any molecule that stimulates erythropoiesis. In some embodiments, an ESA is an erythropoiesis stimulating protein. As used herein, “erythropoiesis stimulating protein” means any protein that directly or indirectly causes activation of the erythropoietin receptor, for example, by binding to and causing dimerization of the receptor. Erythropoiesis stimulating proteins include erythropoietin and variants, analogs, or derivatives thereof that bind to and activate erythropoietin receptor; antibodies that bind to erythropoietin receptor and activate the receptor; or peptides that bind to and activate erythropoietin receptor. Erythropoiesis stimulating proteins include, but are not limited to, Epogen® (epoetin alfa), Aranesp® (darbepoetin alfa), Dynepo® (epoetin delta), Mircera® (methyoxy polyethylene glycol-epoetin beta), Hematide®, MRK-2578, INS-22, Retacrit® (epoetin zeta), Neorecormon® (epoetin beta), Silapo® (epoetin zeta), Binocrit® (epoetin alfa), epoetin alfa Hexal, Abseamed® (epoetin alfa), Ratioepo® (epoetin theta), Eporatio® (epoetin theta), Biopoin® (epoetin theta), epoetin alfa, epoetin beta, epoetin iota, epoetin omega, epoetin delta, epoetin zeta, epoetin theta, and epoetin delta, pegylated erythropoietin, carbamylated erythropoietin, as well as the molecules or variants or analogs thereof.

Among particular illustrative proteins are the specific proteins set forth below, including fusions, fragments, analogs, variants or derivatives thereof: OPGL specific antibodies, peptibodies, related proteins, and the like (also referred to as RANKL specific antibodies, peptibodies and the like), including fully humanized and human OPGL specific antibodies, particularly fully humanized monoclonal antibodies; Myostatin binding proteins, peptibodies, related proteins, and the like, including myostatin specific peptibodies; IL-4 receptor specific antibodies, peptibodies, related proteins, and the like, particularly those that inhibit activities mediated by binding of IL-4 and/or IL-13 to the receptor; Interleukin 1-receptor 1 (“IL1-R1”) specific antibodies, peptibodies, related proteins, and the like; Ang2 specific antibodies, peptibodies, related proteins, and the like; NGF specific antibodies, peptibodies, related proteins, and the like; CD22 specific antibodies, peptibodies, related proteins, and the like, particularly human CD22 specific antibodies, such as but not limited to humanized and fully human antibodies, including but not limited to humanized and fully human monoclonal antibodies, particularly including but not limited to human CD22 specific IgG antibodies, such as, a dimer of a human-mouse monoclonal hLL2 gamma-chain disulfide linked to a human-mouse monoclonal hLL2 kappa-chain, for example, the human CD22 specific fully humanized antibody in Epratuzumab, CAS registry number 501423-23-0; IGF-1 receptor specific antibodies, peptibodies, and related proteins, and the like including but not limited to anti-IGF-1R antibodies; B-7 related protein 1 specific antibodies, peptibodies, related proteins and the like (“B7RP-1” and also referring to B7H2, ICOSL, B7h, and CD275), including but not limited to B7RP-specific fully human monoclonal IgG2 antibodies, including but not limited to fully human IgG2 monoclonal antibody that binds an epitope in the first immunoglobulin-like domain of B7RP-1, including but not limited to those that inhibit the interaction of B7RP-1 with its natural receptor, ICOS, on activated T cells; IL-15 specific antibodies, peptibodies, related proteins, and the like, such as, in particular, humanized monoclonal antibodies, including but not limited to HuMax IL-15 antibodies and related proteins, such as, for instance, 145c7; IFN gamma specific antibodies, peptibodies, related proteins and the like, including but not limited to human IFN gamma specific antibodies, and including but not limited to fully human anti-IFN gamma antibodies; TALL-1 specific antibodies, peptibodies, related proteins, and the like, and other TALL specific binding proteins; Parathyroid hormone (“PTH”) specific antibodies, peptibodies, related proteins, and the like; Thrombopoietin receptor (“TPO-R”) specific antibodies, peptibodies, related proteins, and the like; Hepatocyte growth factor (“HGF”) specific antibodies, peptibodies, related proteins, and the like, including those that target the HGF/SF: cMet axis (HGF/SF: c-Met), such as fully human monoclonal antibodies that neutralize hepatocyte growth factor/scatter (HGF/SF); TRAIL-R2 specific antibodies, peptibodies, related proteins and the like; Activin A specific antibodies, peptibodies, proteins, and the like; TGF-beta specific antibodies, peptibodies, related proteins, and the like; Amyloid-beta protein specific antibodies, peptibodies, related proteins, and the like; c-Kit specific antibodies, peptibodies, related proteins, and the like, including but not limited to proteins that bind c-Kit and/or other stem cell factor receptors; OX40L specific antibodies, peptibodies, related proteins, and the like, including but not limited to proteins that bind OX40L and/or other ligands of the OX40 receptor; Activase® (alteplase, tPA); Aranesp® (darbepoetin alfa) Erythropoietin [30-asparagine, 32-threonine, 87-valine, 88-asparagine, 90-threonine], Darbepoetin alfa, novel erythropoiesis stimulating protein (NESP); Epogen® (epoetin alfa, or erythropoietin); GLP-1, Avonex® (interferon beta-1a); Bexxar® (tositumomab, anti-CD22 monoclonal antibody); Betaseron® (interferon-beta); Campath® (alemtuzumab, anti-CD52 monoclonal antibody); Dynepo® (epoetin delta); Velcade® (bortezomib); MLN0002 (anti-α4β7 mAb); MLN1202 (anti-CCR2 chemokine receptor mAb); Enbrel® (etanercept, TNF-receptor/Fc fusion protein, TNF blocker); Eprex® (epoetin alfa); Erbitux® (cetuximab, anti-EGFR/HER1/c-ErbB-1); Genotropin® (somatropin, Human Growth Hormone); Herceptin® (trastuzumab, anti-HER2/neu (erbB2) receptor mAb); Kanjinti™ (trastuzumab-anns) anti-HER2 monoclonal antibody, biosimilar to Herceptin®, or another product containing trastuzumab for the treatment of breast or gastric cancers; Humatrope® (somatropin, Human Growth Hormone); Humira® (adalimumab); Vectibix® (panitumumab), Xgeva® (denosumab), Prolia® (denosumab), Immunoglobulin G2 Human Monoclonal Antibody to RANK Ligand, Enbrel® (etanercept, TNF-receptor/Fc fusion protein, TNF blocker), Nplate® (romiplostim), rilotumumab, ganitumab, conatumumab, brodalumab, insulin in solution; Infergen® (interferon alfacon-1); Natrecor® (nesiritide; recombinant human B-type natriuretic peptide (hBNP); Kineret® (anakinra); Leukine® (sargamostim, rhuGM-CSF); LymphoCide® (epratuzumab, anti-CD22 mAb); Benlysta™ (lymphostat B, belimumab, anti-BlyS mAb); Metalyse® (tenecteplase, t-PA analog); Mircera® (methoxy polyethylene glycol-epoetin beta); Mylotarg® (gemtuzumab ozogamicin); Raptiva® (efalizumab); Cimzia® (certolizumab pegol, CDP 870); Soliris™ (eculizumab); pexelizumab (anti-C5 complement); Numax® (MEDI-524); Lucentis® (ranibizumab); Panorex® (17-1A, edrecolomab); Trabio® (lerdelimumab); TheraCim hR3 (nimotuzumab); Omnitarg (pertuzumab, 2C4); Osidem® (IDM-1); OvaRex® (B43.13); Nuvion® (visilizumab); cantuzumab mertansine (huC242-DM1); NeoRecormon® (epoetin beta); Neumega® (oprelvekin, human interleukin-11); Orthoclone OKT3® (muromonab-CD3, anti-CD3 monoclonal antibody); Procrit® (epoetin alfa); Remicade® (infliximab, anti-TNFα monoclonal antibody); Reopro® (abciximab, anti-GP IIia/IIia receptor monoclonal antibody); Actemra® (anti-IL6 Receptor mAb); Avastin® (bevacizumab), HuMax-CD4 (zanolimumab); Mvasi™ (bevacizumab-awwb); Rituxan® (rituximab, anti-CD20 mAb); Tarceva® (erlotinib); Roferon-A®-(interferon alfa-2a); Simulect® (basiliximab); Prexige® (lumiracoxib); Synagis® (palivizumab); 145c7-CHO (anti-IL 15 antibody, see U.S. Pat. No. 7,153,507); Tysabri® (natalizumab, anti-α4integrin mAb); Valortim® (MDX-1303, anti-B. anthracis protective antigen mAb); ABthrax™; Xolair® (omalizumab); ETI211 (anti-MRSA mAb); IL-1 trap (the Fc portion of human IgG1 and the extracellular domains of both IL-1 receptor components (the Type I receptor and receptor accessory protein)); VEGF trap (Ig domains of VEGFR1 fused to IgG1 Fc); Zenapax® (daclizumab); Zenapax® (daclizumab, anti-IL-2Ra mAb); Zevalin® (ibritumomab tiuxetan); Zetia® (ezetimibe); Orencia® (atacicept, TACI-Ig); anti-CD80 monoclonal antibody (galiximab); anti-CD23 mAb (lumiliximab); BR2-Fc (huBR3/huFc fusion protein, soluble BAFF antagonist); CNTO 148 (golimumab, anti-TNFα mAb); HGS-ETR1 (mapatumumab; human anti-TRAIL Receptor-1 mAb); HuMax-CD20 (ocrelizumab, anti-CD20 human mAb); HuMax-EGFR (zalutumumab); M200 (volociximab, anti-α5β1 integrin mAb); MDX-010 (ipilimumab, anti-CTLA-4 mAb and VEGFR-1 (IMC-18F1); anti-BR3 mAb; anti-C. difficile Toxin A and Toxin B C mAbs MDX-066 (CDA-1) and MDX-1388); anti-CD22 dsFv-PE38 conjugates (CAT-3888 and CAT-8015); anti-CD25 mAb (HuMax-TAC); anti-CD3 mAb (NI-0401); adecatumumab; anti-CD30 mAb (MDX-060); MDX-1333 (anti-IFNAR); anti-CD38 mAb (HuMax CD38); anti-CD40L mAb; anti-Cripto mAb; anti-CTGF Idiopathic Pulmonary Fibrosis Phase I Fibrogen (FG-3019); anti-CTLA4 mAb; anti-eotaxin1 mAb (CAT-213); anti-FGF8 mAb; anti-ganglioside GD2 mAb; anti-ganglioside GM2 mAb; anti-GDF-8 human mAb (MYO-029); anti-GM-CSF Receptor mAb (CAM-3001); anti-HepC mAb (HuMax HepC); anti-IFNa mAb (MEDI-545, MDX-198); anti-IGF1R mAb; anti-IGF-1R mAb (HuMax-Inflam); anti-IL 12 mAb (ABT-874); anti-IL 12/IL23 mAb (CNTO 1275); anti-IL13 mAb (CAT-354); anti-IL2Ra mAb (HuMax-TAC); anti-IL5 Receptor mAb; anti-integrin receptors mAb (MDX-018, CNTO 95); anti-IP10 Ulcerative Colitis mAb (MDX-1100); BMS-66513; anti-Mannose Receptor/hCGβ mAb (MDX-1307); anti-mesothelin dsFv-PE38 conjugate (CAT-5001); anti-PD1mAb (MDX-1106 (ONO-4538); anti-PDGFRα antibody (IMC-3G3); anti-TGFβ mAb (GC-1008); anti-TRAIL Receptor-2 human mAb (HGS-ETR2); anti-TWEAK mAb; anti-VEGFR/Flt-1 mAb; and anti-ZP3 mAb (HuMax-ZP3).

In some embodiments, the drug delivery device may contain or be used with a sclerostin antibody, such as but not limited to romosozumab, blosozumab, BPS 804 (Novartis), Evenity™ (romosozumab-aqqg), another product containing romosozumab for treatment of postmenopausal osteoporosis and/or fracture healing and in other embodiments, a monoclonal antibody (IgG) that binds human Proprotein Convertase Subtilisin/Kexin Type 9 (PCSK9). Such PCSK9 specific antibodies include, but are not limited to, Repatha® (evolocumab) and Praluent® (alirocumab). In other embodiments, the drug delivery device may contain or be used with rilotumumab, bixalomer, trebananib, ganitumab, conatumumab, motesanib diphosphate, brodalumab, vidupiprant or panitumumab. In some embodiments, the reservoir of the drug delivery device may be filled with or the device can be used with IMLYGIC® (talimogene laherparepvec) or another oncolytic HSV for the treatment of melanoma or other cancers including but are not limited to OncoVEXGALV/CD; OrienX010; G207, 1716; NV1020; NV12023; NV1034; and NV1042. In some embodiments, the drug delivery device may contain or be used with endogenous tissue inhibitors of metalloproteinases (TIMPs) such as but not limited to TIMP-3. In some embodiments, the drug delivery device may contain or be used with Aimovig® (erenumab-aooe), anti-human CGRP-R (calcitonin gene-related peptide type 1 receptor) or another product containing erenumab for the treatment of migraine headaches. Antagonistic antibodies for human calcitonin gene-related peptide (CGRP) receptor such as but not limited to erenumab and bispecific antibody molecules that target the CGRP receptor and other headache targets may also be delivered with a drug delivery device of the present disclosure. Additionally, bispecific T cell engager (BiTE®) molecules such as but not limited to BLINCYTO® (blinatumomab) can be used in or with the drug delivery device of the present disclosure. In some embodiments, the drug delivery device may contain or be used with an APJ large molecule agonist such as but not limited to apelin or analogues thereof. In some embodiments, a therapeutically effective amount of an anti-thymic stromal lymphopoietin (TSLP) or TSLP receptor antibody is used in or with the drug delivery device of the present disclosure. In some embodiments, the drug delivery device may contain or be used with Avsola™ (infliximab-axxq), anti-TNFα monoclonal antibody, biosimilar to Remicade® (infliximab) (Janssen Biotech, Inc.) or another product containing infliximab for the treatment of autoimmune diseases. In some embodiments, the drug delivery device may contain or be used with Kyprolis® (carfilzomib), (2S)-N—((S)-1-((S)-4-methyl-1-((R)-2-methyloxiran-2-yl)-1-oxopentan-2-ylcarbamoyl)-2-phenylethyl)-2-((S)-2-(2-morpholinoacetamido)-4-phenylbutanamido)-4-methylpentanamide, or another product containing carfilzomib for the treatment of multiple myeloma. In some embodiments, the drug delivery device may contain or be used with Otezla® (apremilast), N-[2-[(1S)-1-(3-ethoxy-4-methoxyphenyl)-2-(methylsulfonyl)ethyl]-2,3-dihydro-1,3-dioxo-1H-isoindol-4-yl]acetamide, or another product containing apremilast for the treatment of various inflammatory diseases. In some embodiments, the drug delivery device may contain or be used with Parsabiv™ (etelcalcetide HCl, KAI-4169) or another product containing etelcalcetide HCl for the treatment of secondary hyperparathyroidism (sHPT) such as in patients with chronic kidney disease (KD) on hemodialysis. In some embodiments, the drug delivery device may contain or be used with ABP 798 (rituximab), a biosimilar candidate to Rituxan®/MabThera™, or another product containing an anti-CD20 monoclonal antibody. In some embodiments, the drug delivery device may contain or be used with a VEGF antagonist such as a non-antibody VEGF antagonist and/or a VEGF-Trap such as aflibercept (Ig domain 2 from VEGFR1 and Ig domain 3 from VEGFR2, fused to Fc domain of IgG1). In some embodiments, the drug delivery device may contain or be used with ABP 959 (eculizumab), a biosimilar candidate to Soliris®, or another product containing a monoclonal antibody that specifically binds to the complement protein C5. In some embodiments, the drug delivery device may contain or be used with Rozibafusp alfa (formerly AMG 570) is a novel bispecific antibody-peptide conjugate that simultaneously blocks ICOSL and BAFF activity. In some embodiments, the drug delivery device may contain or be used with Omecamtiv mecarbil, a small molecule selective cardiac myosin activator, or myotrope, which directly targets the contractile mechanisms of the heart, or another product containing a small molecule selective cardiac myosin activator. In some embodiments, the drug delivery device may contain or be used with Sotorasib (formerly known as AMG 510), a KRASG12C small molecule inhibitor, or another product containing a KRASG12C small molecule inhibitor. In some embodiments, the drug delivery device may contain or be used with Tezepelumab, a human monoclonal antibody that inhibits the action of thymic stromal lymphopoietin (TSLP), or another product containing a human monoclonal antibody that inhibits the action of TSLP. In some embodiments, the drug delivery device may contain or be used with AMG 714, a human monoclonal antibody that binds to Interleukin-15 (IL-15) or another product containing a human monoclonal antibody that binds to Interleukin-15 (IL-15). In some embodiments, the drug delivery device may contain or be used with AMG 890, a small interfering RNA (siRNA) that lowers lipoprotein (a), also known as Lp (a), or another product containing a small interfering RNA (siRNA) that lowers lipoprotein (a). In some embodiments, the drug delivery device may contain or be used with ABP 654 (human IgG1 kappa antibody), a biosimilar candidate to Stelara®, or another product that contains human IgG1 kappa antibody and/or binds to the p40 subunit of human cytokines interleukin (IL)-12 and IL-23. In some embodiments, the drug delivery device may contain or be used with Amjevita™ or Amgevita™ (formerly ABP 501) (mab anti-TNF human IgG1), a biosimilar candidate to Humira®, or another product that contains human mab anti-TNF human IgG1. In some embodiments, the drug delivery device may contain or be used with AMG 160, or another product that contains a half-life extended (HLE) anti-prostate-specific membrane antigen (PSMA)×anti-CD3 BiTE® (bispecific T cell engager) construct. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 133, or another product containing a gastric inhibitory polypeptide receptor (GIPR) antagonist and GLP-1R agonist. In some embodiments, the drug delivery device may contain or be used with AMG 171or another product containing a Growth Differential Factor 15 (GDF15) analog. In some embodiments, the drug delivery device may contain or be used with AMG 176 or another product containing a small molecule inhibitor of myeloid cell leukemia 1 (MCL-1). In some embodiments, the drug delivery device may contain or be used with AMG 199 or another product containing a half-life extended (HLE) bispecific T cell engager construct (BiTE®). In some embodiments, the drug delivery device may contain or be used with AMG 256 or another product containing an anti-PD-1×IL21 mutein and/or an IL-21 receptor agonist designed to selectively turn on the Interleukin 21 (IL-21) pathway in programmed cell death-1 (PD-1) positive cells. In some embodiments, the drug delivery device may contain or be used with AMG 330 or another product containing an anti-CD33 ×anti-CD3 BiTE® (bispecific T cell engager) construct. In some embodiments, the drug delivery device may contain or be used with AMG 404 or another product containing a human anti-programmed cell death-1 (PD-1) monoclonal antibody being investigated as a treatment for patients with solid tumors. In some embodiments, the drug delivery device may contain or be used with AMG 427 or another product containing a half-life extended (HLE) anti-fms-like tyrosine kinase 3 (FLT3)×anti-CD3 BiTE® (bispecific T cell engager) construct. In some embodiments, the drug delivery device may contain or be used with AMG 430 or another product containing an anti-Jagged-1 monoclonal antibody. In some embodiments, the drug delivery device may contain or be used with AMG 506 or another product containing a multi-specific FAP×4-1BB-targeting DARPin® biologic under investigation as a treatment for solid tumors. In some embodiments, the drug delivery device may contain or be used with AMG 509 or another product containing a bivalent T-cell engager and is designed using XmAb® 2+1 technology. In some embodiments, the drug delivery device may contain or be used with AMG 562 or another product containing a half-life extended (HLE) CD19×CD3 BiTE® (bispecific T cell engager) construct. In some embodiments, the drug delivery device may contain or be used with Efavaleukin alfa (formerly AMG 592) or another product containing an IL-2 mutein Fc fusion protein. In some embodiments, the drug delivery device may contain or be used with AMG 596 or another product containing a CD3×epidermal growth factor receptor vIII (EGFRvIII) BiTE® (bispecific T cell engager) molecule. In some embodiments, the drug delivery device may contain or be used with AMG 673 or another product containing a half-life extended (HLE) anti-CD33×anti-CD3 BiTE® (bispecific T cell engager) construct. In some embodiments, the drug delivery device may contain or be used with AMG 701 or another product containing a half-life extended (HLE) anti-B-cell maturation antigen (BCMA)×anti-CD3 BiTE® (bispecific T cell engager) construct. In some embodiments, the drug delivery device may contain or be used with AMG 757 or another product containing a half-life extended (HLE) anti-delta-like ligand 3 (DLL3)×anti-CD3 BiTE® (bispecific T cell engager) construct. In some embodiments, the drug delivery device may contain or be used with AMG 910 or another product containing a half-life extended (HLE) epithelial cell tight junction protein claudin 18.2×CD3 BiTE® (bispecific T cell engager) construct.

Although the drug delivery devices, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. A system for dispensing, inspecting, and/or processing a drug comprising:
a tray adapted to be operably coupled with a workstation, the tray having a body defining a recessed region and a sidewall positioned adjacent to the recessed region;
a handle member operably coupled with the tray, the handle member positioned at or near a first corner of the tray; and
a funnel region operably coupled with the tray, the funnel region positioned at or near a second corner of the tray, the first corner being opposite the second corner.

2. The system of claim 1, further comprising a hopper positioned adjacent to a length of the body of the tray.

3. The system of claim 2, wherein the hopper comprises a single use hopper adapted to be removably positioned adjacent to the length of the body of the tray.

4. The system of claim 1, wherein (a) the body of the tray includes a ridge extending from a portion of the recessed region and/or (b) the funnel region includes a ramp extending from the recessed region to an upper edge of the sidewall.

5. The system of claim 1, wherein the handle member includes an arm member extending outwardly from the first corner of the tray and a gripping member operably coupled with the arm member.

6. The system of claim 5, wherein the arm member is pivotably coupled with the first corner of the tray.

7. (canceled)

8. The system of claim 1, further comprising an edge guide positioned adjacent to the second corner of the tray.

9. The system of claim 8, wherein the edge guide comprises a raised wall extending from the sidewall of the body of the tray.

10. The system of claim 1, wherein the tray further includes a flange extending around at least a portion of the sidewall, the flange adapted to rest upon a portion of the drug processing system.

11. The system of claim 1, wherein the tray is constructed from a vacuum molded material.

12. A drug processing system comprising:
a workstation including a platform and an imaging system;
a dispensing system including:
a tray adapted to be operably coupled with the workstation, the tray having a body defining a recessed region and a sidewall positioned adjacent to the recessed region;
a handle member operably coupled with the tray, the handle member positioned at or near a first corner of the tray;
a funnel region operably coupled with the tray, the funnel region positioned at or near a second corner of the tray, the first corner being opposite the second corner; and
a counting system operably coupled with the workstation, the counting system adapted to count a quantity of items sensed by the imaging system that are disposed on the recessed region of the tray.

13. The drug processing system of claim 12, further comprising a hopper positioned adjacent to a length of the body of the tray and along a portion of the workstation.

14. The drug processing system of claim 13, wherein the hopper comprises a single use hopper adapted to be removably positioned adjacent to the length of the body of the tray.

15. The drug processing system of claim 12, wherein (a) the body of the tray includes a ridge extending from a portion of the recessed region, (b) the handle member includes an arm member extending outwardly from the first corner of the tray and a gripping member operably coupled with the arm member, and/or (c) the funnel region includes a ramp extending from the recessed region to an upper edge of the sidewall.

16. (canceled)

17. (canceled)

18. The drug processing system of claim 12, further comprising an edge guide positioned adjacent to the second corner of the tray.

19. The drug dispensing system of claim 12, wherein the tray further includes a flange extending around at least a portion of the sidewall, the flange adapted to rest upon a portion of the workstation.

20. A drug processing system comprising:
a workstation including a base and an elevated platform operably coupled with the base; and
an inspection system including:
a tray adapted to be at least partially operably coupled with at least a portion of the elevated platform, the tray having a body defining a recessed region and a sidewall positioned adjacent to the recessed region, the tray being constructed from an optically transparent material; and
a funnel region operably coupled with the tray, the funnel region positioned at or near a corner of the tray.

21. The drug processing system of claim 20, wherein the elevated platform includes:
at least one arm operably coupled with the base, the at least one arm including an upright member extending upwardly from the base; and
a platform frame operably coupled with the upright member of the at least one arm, the platform frame defining an opening to receive at least a portion of the tray.

22. The drug processing system of claim 20, further comprising a reflective member positioned below the tray.

23. The drug processing system of claim 20, wherein the dispensing system further includes a handle member operably coupled with the tray, the handle member positioned at or near a corner of the tray that is opposite the funnel region.
